(19) United States
(12) Patent Application Publication
(10) Pub. No.: US 2015/0363572 A1
(43) Pub. Date: Dec. 17, 2015

(54) System and Method for Providing Emergency Medical Counselling

(71) Applicants: Helge Myklebust, Stavanger (NO); Geir Strand, Stavanger (NO)

(72) Inventors: Helge Myklebust, Stavanger (NO); Geir Strand, Stavanger (NO)

(21) Appl. No.: 14/303,737

(22) Filed: Jun. 13, 2014

(51) Int. Cl. G06F 19/00

(52) U.S. Cl. CPC G06F 19/3481; G06F 19/322; G06F 19/345

(57) ABSTRACT

A method and system for providing emergency medical counselling to a rescuer is disclosed. The method comprises transmitting a first data set comprising first temporal data, first positional data and first medical data from a first position to a central server and transmitting a second data set comprising second temporal data, second positional data and medical data from a second position to the central server (150). The central server (150) matches (380) in the first temporal data (32a) and the first positional data (34a) with the second temporal data (32b) and the second positional data (34b) to associate the first set of data (30a) with the second set of data (30b) to thereby obtain a medical history dataset (195) comprising at least the first medical data (36a) and the second medical data (36b).

### CROSS-REFERENCE TO RELATED APPLICATIONS

None

### FIELD OF THE INVENTION

The field of the invention relates to a method and a system as well as a mobile station for providing emergency medical counselling to a rescuer who is aiding a patient.

### BACKGROUND OF THE INVENTION

The concept of a “chain of survival” refers to a series of actions that, when put into motion, substantially reduce the mortality associated with a cardiac arrest of a patient. The chain of survival is, however, only as strong as its weakest link. The four inter-dependent links in the chain of survival are: i) early access to the patient, ii) early cardio pulmonary resuscitation (CPR) on the patient, ii) early defibrillation and iv) early advanced cardiac life support. Each of these links needs to be supported if the chance of survival of the patient is to be increased.

Ideally, a bystander recognising an impending cardiac arrest should contact an emergency services centre as soon as possible and, in order to be most affective, CPR should be provided immediately after collapse of the patient. It is known that properly performed CPR can keep the heart, brain and other vital organs alive for ten to twelve minutes longer, which can substantially increase the chance of survival. Studies have shown that about half of the bystanders or rescuers have some degree of CPR training and would therefore be capable of providing early CPR. However, only about one third of those trained in CPR actually performed CPR on the patient suffering the cardiac arrest. The reasons for this are multi-fold. The bystanders may have panicked, are afraid of doing harm, or do not understand that the patient was in cardiac arrest. There is therefore a need to encourage these bystanders to perform CPR correctly.

One method for supporting bystanders as rescuers is to use assistance from a dispatcher. A method and system for giving remote emergency medical counsel to potential rescuers of patients is known from U.S. Pat. No. 6,053,864 (Clawson), which uses a series of flash cards to enable a dispatcher in an emergency medical services centre to guide the rescuer through the steps of a procedure for giving remote emergency medical counsel, such as CPR, to the patient. This system has been implemented in some emergency medical services centres, but currently does not provide any feedback to the dispatcher on the progress of the CPR, other than voice communication with the rescuer or another bystander.

U.S. Pat. No. 6,459,933 (Lurie et al.) teaches a method for providing medical treatment to a patient at a location, which is away from a medical facility. The method provides that at least one physical parameter of the patient is monitored with a monitoring device and the physical parameter, such as a heartbeat, is subsequently transmitted to a central controller that is located within the medical facility. A control signal is transmitted from the controller to operate a treatment device that is coupled to the patient. This patent does not, however, disclose a system in which a rescuer is supported in providing emergency medical care to the patient.

### SUMMARY OF THE INVENTION

This disclosure teaches a method for providing emergency medical counselling to a rescuer which comprises transmitting a first set of data relating to the patient and comprising first temporal data, first positional data and first medical data from a first position to a central position. A second set of data relating to the same patient and comprising temporal data, positional data and medical data from a second position is also provided to the central server. The central server can match the first temporal data and the first positional data with the second temporal data and the second positional data to associate the first set of data with the second set of data and thereby obtain a medical history data set for the patient, comprising at least the first medical data and the second medical data. The match occurs because at at least one point in time, the first position and the second position will be substantially the same and the central server will be able to determine this match.

The first positional data indicates the position of the patient on collapse. The first medical data will then relate to data from treatment by a rescuer on the spot. The second positional data relates to the position of an emergency services vehicle on arrival at the scene or the position of medical equipment carried from the vehicle to the patient. The second medical data will be medical data that has been obtained from a paramedic at the scene of the patient. The central server is able to take the first and second data sets, gathered independently from each other, and combine the two data sets in order to provide a complete record of the process of the emergency medical treatment. This can then be made available to the paramedics in the emergency services vehicle or to a doctor at a hospital or other medical facility on arrival of the patient. The complete record can be used to improve system of care by better training, better procedures, better equipment, increase motivation and understanding of the mechanism of resuscitation.

This disclosure also teaches a system for providing an automated emergency medical record of a patient treatment, which comprises a data receiver for receiving the first data set and the second data set as well as a processor for matching the first temporal data and the first positional data with the second temporal data and the second positional data. This then allows the association of the first data set with the second data set to obtain a complete medical history data set, as explained above.

In one aspect of this invention the first medical data is obtained from a CPR card placed on the chest of the patient in order to measure the depth and rate of compression. This first medical data is provided through to the central server for access by the dispatcher. The first medical data can be transferred by means of a mobile station, such as a smartphone, which has a data receiver and a data transmitter. The dispatcher can also communicate with the rescuer through the loudspeaker and/or the microphone detached to the mobile station.

### DESCRIPTION OF THE FIGURES

FIG. 1 shows an overview of the system of this disclosure.

FIG. 2 shows an example of the data sets.

FIG. 3 shows an outline of the method of this disclosure.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

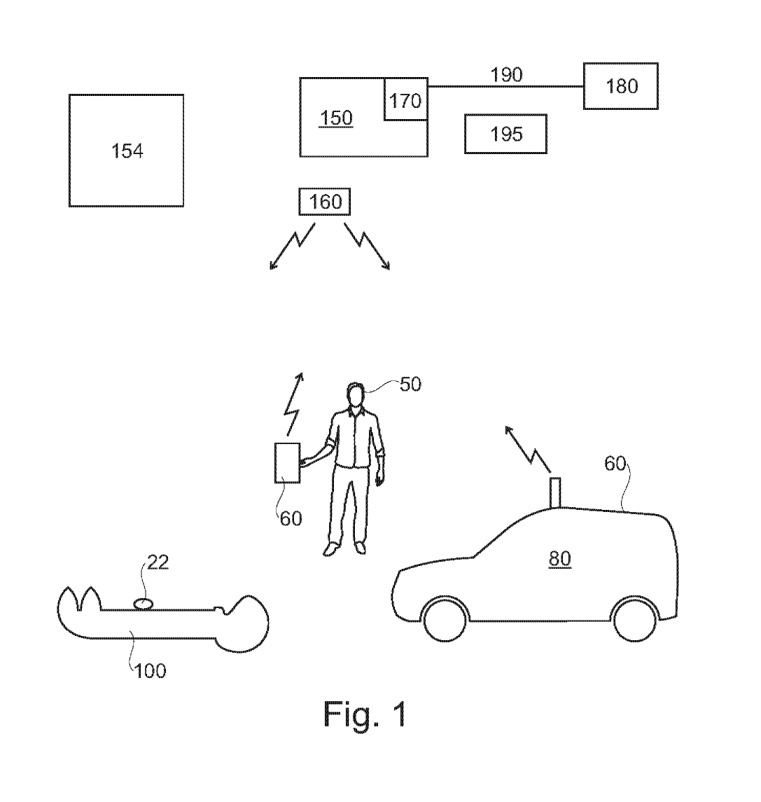

FIG. 1 shows a first aspect of the system of the current disclosure. In this aspect of the disclosure, it is assumed that a patient 100 has already collapsed and is being attended by a rescuer 50. It will be assume that the rescuer 50 has been trained in cardiopulmonary resuscitation (CPR) and has a smartphone 60. This is, however, not limiting of the invention and it is possible that the rescuer 50 has not been trained in CPR but has some basic knowledge of first aid. It is also possible that the rescuer 50 uses a device other than a smartphone 60. For example, the rescuer 50 may use a dedicated emergency service radio device or other data transmission device, such as a tablet or mobile computer. These devices will be commonly termed a mobile station 60. The mobile station 60 includes a local memory 62 for storing applications programs, also called apps, and data. The mobile station 60 includes further a GPS receiver or similar positioning means 64 for generating positional data from a GPS signal and a clock 66 for maintaining real time and producing temporal data. It will be known that the temporal data can also be obtained from the GPS signal and thus the clock 66 may also be part of the GPS receiver 64. The clock 66 may also be arranged in a central server that connects to the mobile station 60. A receiver 67 is present which receives data over a number of protocols, including but not limited to the Bluetooth protocol. A transmitter 69 can transfer data, including the temporal data and the positional data.

The rescuer may be equipped with a so-called CPR card 22. The CPR card 22 is produced, for example, by the Laerdal Medical Company and is able to measure and record the rate and depth of chest compressions (pushing up and down on the chest performed by the rescuer 50 on the patent 100). It is also possible that other devices, like the CPR Meter, are used to record this information.

The smartphone 60 will be provided an application program in the local memory 62, which has already been downloaded from a central repository 155, such as from Google Play or iTunes, and installed on the smartphone 60. The CPR card 22 transmits continuously or regularly first medical data 36a relating to the rate and depth of the chest compression to the smartphone 60 for example by means of a Bluetooth or similar protocol and is received by the receiver 67. The smartphone 60 transmits continuously or regularly using the transmitter 69 as a first data set 30 the received first medical data 36a from the CPR card 22, together with first temporal data 32a, obtained either from the GPS signal received by the smartphone 60 or from an internal clock 66, as well as first positional data 34a obtained from the GPS system or other positional device. In addition and without limitation, voice data, video data, acceleration data, temperature data, light data may also be recorded by the smartphone 60 and communicated as part of the first medical data 36a.

This first data set 30a is transmitted to a central server 150 and received at a data receiver 160. It will be understood that the transmission between the smartphone 60 and the data receiver 160 is carried out using a mobile telecommunications system in this aspect of the invention. It would be possible to use a number of different protocols, such as UMTS (3G), LTE (4G) or even EDGE (2G) data transfer protocols. Alternatively a Wi-Fi protocol could be used if this is available locally. The central server 150 stores the first data set 30a in a database as medical history data set 195. The medical history data set 195 is a collocation of the received first data sets 30a.

The medical history data set 195 can be accessed by trained medical personal. In one aspect of the disclosure the trained medical personal could include a dispatcher located, for example, in an emergency services centre, such as a hospital 180 or other medical facility. Access is made via a communications link 190. The dispatcher is able to receive the medical history data set 195 on a continuous basis from the central server 150.

In one aspect of the invention the dispatcher is also able to communicate with the rescuer 50 by means of a loud speaker 63 at the smartphone 60. Communication is via a mobile telecommunications system. A microphone 65 is provided at the smartphone 60 and can be accessed by the app in the smartphone 60 to enable the rescuer 50 to communicate with the dispatcher. In one further aspect, the dispatcher is able to send a control signal to the smartphone 60, which enables the use of the loudspeaker 63, video camera, accelerometer or other sensors found on a smartphone such that the information from the sensor is communicated to the dispatcher and made useful to the dispatcher as for instance live video displayed on a monitor in front of the dispatcher.

The application program stored in the smartphone 60 can provide additional features. For example, the application program can access a Bluetooth interface on the smartphone 60 to pair the CPR card 22 (or other devices) with the smartphone 60. Other protocols, such as the IEEE 802.x protocol, can also be used for this communication. The application program can also call the appropriate emergency medical phone number, and can determine this from the location of the smartphone 60. The application program also has a function to activate the loudspeaker 63 when connection has been established as well as setting the loudspeaker volume to a high level and the illumination of the display of the smartphone 60 to bright.

The dispatcher calls an emergency services vehicle 65 to the location of the patient 100. The dispatcher is able to obtain the exact coordinates of the patent 100 from the first positional data 34a received from the smartphone 60. This enables the emergency services vehicle 65 to arrive promptly at the location of the patent 100. It is also possible for the app on the smartphone 60 to automatically call the emergency services vehicle 65 by sending the first positional data 34a of the smart phone 60 together with an emergency signal or other indication that the patient 100 is requiring emergency medical counselling.

The emergency services vehicle 65 has a number of medical devices in the vehicle, which are shown schematically as block 80 in the emergency services vehicle 65. The emergency services vehicle 65 is also able to communicate a second data set 30b with the data receiver 160 over a mobile telecommunications link. The second data set 30b comprises second medical data 36b from the second set of medical devices 80 and is transmitted across the telecommunications link, together with second temporal data 32b and second positional data 34b from the location of the emergency services vehicle 60.

The central server 150 is able to match the first temporal data 32a and the first positional data 34a from the smartphone 60 with the second temporal data 32b and the second positional data 34b from the emergency vehicle 65. The central server 150 will therefore identify that the first medical data 36a from the smartphone is associated with the same patient 100 as the second medical data 36b received from the emergency services vehicle 60. The central server 150 can therefore match the first data set 30a and the second data set 30b with each other to create the combined medical history data set 195.

The combined medical history data set 195 is supplied to the dispatcher (as noted above), but can also be supplied to the paramedics while at scene, to a doctor/medical director or at the hospital 180 or other medical facility. Non-limiting examples of the other medical facilities include a national or international cardiac arrest registry, like CARES or EUREKA. It will be appreciated that a hospital 180 could also be a clinic or similar.

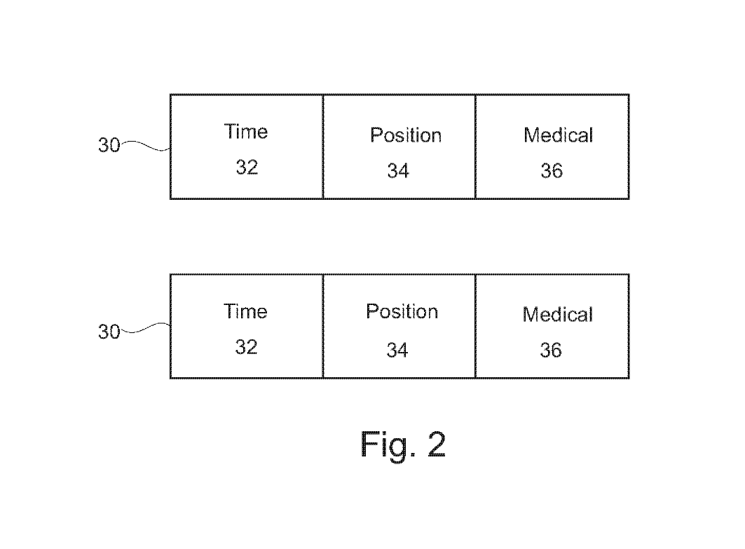

FIG. 2 shows an example of the first data set 30a and the second data set 30b. The data sets 30a and 30b comprise at least three data fields including temporal data 32a and 32b, position data 34a and 34b and at least one item of medical data 36a and 36b per data set 30a and 30b. It will be appreciated that the medical data 36a and 36b will at least relate to the rate and depth of chest compression on the patient 100. It is equally possible that the medical data 36a and 36b relates to other medical parameters, such as the heart rate. For example the emergency services vehicle 65 can include other devices such as a defibrillator or a respiratory profile motor, which monitors standard parameters, like tidal CO₂, O₂ saturation, inspiratory and expiratory tidal volume and similar, as well as the patient temperature, shock delivery and other medical events. The data relating to these other medical parameters from these devices is provided as the second medical data 36b in additional data fields, which are not shown on FIG. 2. It is equally possible that the smartphone 60 transmits some or similar data and could receive the first medical data 36a from portable medical devices in addition to the CPR card 22.

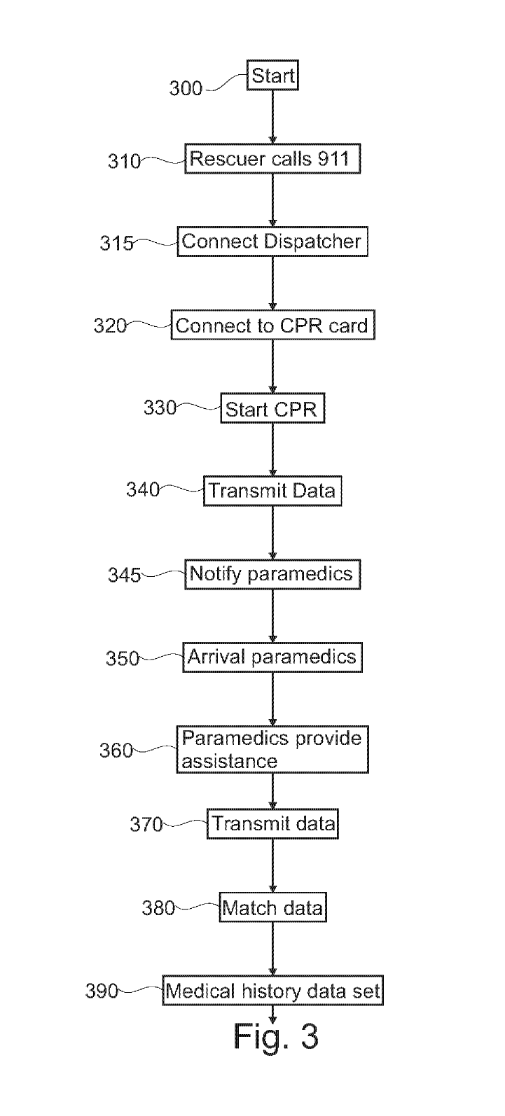

FIG. 3 shows an outline of the method for providing emergency medical counselling, according to one aspect of this invention. The procedure starts in step 300. It is assumed that the patient 100 collapses or otherwise shows signs of medical distress. The rescuer 50 will call in step 310 the emergency telephone number for the emergency services centre, such as 911 in the United States, 000 in Australia or 112 in Europe. It will be assumed for purposes of this disclosure that the rescuer 50 is a trained rescuer and has already downloaded the app onto his or her smartphone 60, but the app could also be downloaded in real-time. This app can be used to automatically call the emergency services number (911, 000, 112) and also to turn on the smartphone's 60 microphone and loudspeaker, as noted above. A connection is made in step 315 to the dispatcher who is then able to aid the rescuer 50.

The rescuer 50 has the CPR card 22 and places this CPR card 22 on a patient's 100 chest in a suitable position. The CPR card 22 connects through a communications link to the smartphone 60 in step 320. The rescuer 50 then starts CPR in step 330 and the CPR card 22 measures the rate and depth of the chest impressions in step 340 and transmits this data to the smartphone 60. The rescuer 50 is encouraged by the dispatcher to change the rate and depth of chest compression if the dispatcher receives the medical data 36a indicating that the rescuer 50 is not performing the CPR in an optimal manner. The CPR card 22 can also include an indication that the CPR is being performed correctly, but encouragement from a dispatcher is advantageous. In one aspect of the disclosure, the smartphone 60 may also provide direct feedback to the rescuer regarding his/her CPR performance. This feedback may be visible on the display of the smartphone 60, audible through the loudspeaker 63 or both.

The dispatcher will notify in step 345 a paramedical service that arrives in the emergency services vehicle 65 in step 350. The emergency services vehicle 65 is connected to the central server 150 and notifies the central server of the arrival of the emergency services vehicle 65 in a location, which is proximate to the patient 100. The paramedics from the emergency service vehicle 65 provide relief the rescuer 50 in step 360. The paramedics can provide additional medical treatment and attach additional medical devices 80 to the patient and the further medical devices 80 transmit the second data set 30b in 370 to the central server 150. The central server 150 can identify that this second data set 30b comes from the same location and is concurrent to the data received from the first data set 30a. The central server 150 will conclude from the matching of the first temporal data 32a and the second temporal data 32b as well as the first positional data 34a and the second positional data 34b that the paramedics are dealing with the same patient 100. The central server 150 has a processor 170 which access the stored first data set 30a and the second data set 30b and creates the combined medical data set in 195 in step 390. The medical history data set 195 can then be either supplied to the paramedics and/or to a hospital to allow treatment of the patient 100 on arrival in the hospital.

What is claimed is:

1. A method for providing emergency medical counselling to a rescuer comprising:
transmitting a first data set comprising first temporal data, first positional data and first medical data from a first position to a central server;
transmitting a second data set comprising second temporal data, second positional data and medical data from a second position to the central server;
matching in the central server the first temporal data and the first positional data with the second temporal data and the second positional data to associate the first set of data with the second set of data to thereby obtain a medical history dataset comprising at least the first medical data and the second medical data.

2. The method of claim 1, further comprising transmitting the medical history dataset to at least one of a hospital, a physician, a clinic or an emergency dispatcher.

3. The method of claim 1, further comprising sending the first medical data from a medical device to a data transmission device prior to transmitting the first medical data.

4. A system for providing emergency medical counselling to a rescuer comprising:
a central server for receiving a first data set comprising first temporal data, first positional data and first medical data from a first position, and a second data set comprising temporal data, positional data and medical data from a second position; a processor for matching the first temporal data and the first positional data with the second temporal data and the second positional data to associate the first data set with the second data set to thereby obtain a medical history dataset comprising at least the first medical data and the second medical data.

5. The system of claim 4, further comprising a data transmitter for transmitting the medical history dataset to a user.

6. The system of claim 4, further comprising a non-transitory memory store for storing a computer program product for downloading onto and running on a mobile station, whereby the computer program product comprises:
first logic for alerting an emergency services centre;
second logic for connecting the mobile station to a portable medical device and transmitting the first medical data from the portable medical device to the mobile station;
third logic for connecting the mobile station to a central server for transmitting the first medical data, the first positional data and the first temporal data.

7. The system of any one of claim 4, further comprising a CPR device placed on the patient and generating the first medical data.

8. A computer program product fixed in non-transitory computer storage medium and having computer-executable instructions for causing a mobile station to contact an emergency services center, connect the mobile station to a portable medical device for transmission of first medical data between the mobile station and the portable medical device, obtain first temporal data and first positional data, and connect the mobile station to a central server for transmission of the first medical data, the first temporal data and the first positional data; wherein the central server is adapted to match the first temporal data and the first positional data with further data sets to identify concurrent data sets and collate the identified concurrent data sets.

9. The computer program product of claim 8 further including computer-executable instructions for causing the mobile station to connect a loudspeaker to a dispatcher.

10. A mobile station for providing emergency medical counselling to a rescuer comprising:
a local memory for storing data;
a receiver for obtaining first positional data;
a clock for generating first temporal data;
a receiver for transferring first medical data from a CPR card to the mobile station;
a transmitter for transferring the first medical data and the first positional data together with first temporal data to a central server for matching with second positional data and second temporal data to identify concurrent second medical data.

11. The mobile station of claim 10 further comprising at least one of a loudspeaker or a microphone for communication to an emergency services centre.
